(19) United States
(12) Patent Application Publication
(10) Pub. No.: US 2003/0212168 A1
(43) Pub. Date: Nov. 13, 2003

(54) Petroleum asphalts modified by liquefied biomass additives

(76) Inventors: Donald H. White, Tucson, AZ (US); Barry A. Cooper, Tucson, AZ (US)

Correspondence Address: DURANDO BIRDWELL & JANKE, P.L.C., 2929 E. BROADWAY BLVD., TUCSON, AZ, 85716, US

(21) Appl. No.: 10/203,447

(22) PCT Filed: Feb. 7, 2001
(86) PCT No.: PCT/US01/03915

(51) Int. Cl. C08L 95/00

(52) U.S. Cl. 524/59; 524/306; 524/310; 524/322; 106/273.1; 106/225; 106/246; 106/269

(57) ABSTRACT

Liquefied biomass (16) obtained from direct liquefaction and/or fast-pyrolysis is reacted with mixtures of fatty acids (24) in the presence of an oxidizer (28) and with various reactive monomer and polymer additives (46, 48, 50) to create tailored compatibilizer-like bio-additives (34) that are compatible with petroleum asphalts. By judiciously selecting appropriate additives and additional constituent, such as non-reactive (18) and reactive diluents (30), these bio-additives can be tailored to modify low-temperature properties, high-temperature properties, compatibility with aggregate materials, application characteristics, and other properties of petroleum asphalts for paving, roofing and sealing uses.

### RELATED APPLICATIONS

This is a continuation-in-part application of copending U.S. Ser. No. 09/500,388, filed on Feb. 8, 2000, which was based on U.S. Provisional Serial No. 60/119,666, filed on Feb. 11, 1999.

### BACKGROUND OF THE INVENTION

1. Field of the Invention

This invention pertains to the field of additives for petroleum asphalts. In particular, it relates to the use of liquefied biomass material reacted with conventional polymeric additives to tailor the properties and performance of such asphalts to particular needs.

2. Description of the Related Art

The increasing volume of road traffic, particularly heavy-vehicle traffic, has created a severe damage problem on many highways and streets in this country. This problem results from elastic-type failures in the structure of the pavement which cause “chicken-wire” or “alligator” cracking patterns in the pavement surface. This cracking is caused by fatigue of the pavement surface from repeated deflection. Conventional repairs by asphalt overlays are usually only effective for short periods of time. On the other hand, major and more drastic repairs, such as replacing the pavement surface and its foundation, are very expensive and are often as ineffective as asphalt overlays for a long-term solution.

The so-called “flexible” type of pavement is actually not a particularly flexible structure. Under certain conditions, flexible-type pavements could actually be classified as very brittle, particularly in cold weather or when the pavement surface has suffered a long period of embrittlement from oxidation and age. When considered on a nationwide scale, the cracking caused by this lack of flexibility has created a tremendous problem. Traveling over the streets and highways of the United States, one can seldom go more than a few miles without finding distressed pavement resulting from repeated flexing of the surface of the pavement under traffic loads.

This type of failure has been variously defined as flexure cracking, elastic-type failure, and fatigue failure. It is characterized by multiple cracking with chicken-wire or alligator type patterns without plastic deformation of the pavement surface. The cracking is due to fatigue of the bituminous pavement mixture from repeated deflection and subsequent recovery of the pavement surface under vehicle load. The deflection and recovery are produced by the elasticity of some member of the substructure or foundation of the pavement surface.

While “fatigue” failure is most prevalent, flexible-type pavements experience other types of failure. For example, the “plastic” type of failure is manifested by cracking in the pavement surface of the same character as found in fatigue failures, but is also accompanied by plastic deformation of the pavement surface. The surface is depressed under load and usually slightly raised at one or both sides of the loaded area. This type of failure is usually caused by inadequate thickness of the base material and is no longer a serious problem on highways or streets built under modern design criteria.

The “surface” type of failure is yet another cause of road damage, characterized by attrition, or stripping and emulsification of the asphalt in the surface of the pavement. Raveling and loss of material occurs in the surface, but with no significant amount of cracking. Although this type of failure is very common, it is not as serious as fatigue-type failure because it can be corrected by the application of a seal coat.

Thus, cracking caused by fatigue failure is entirely different from plastic and surface failures, and solutions for fatigue cracking have been difficult and expensive. The results of repairs are uncertain because the resilience in the substructure must be counteracted either by making the substructure or the surface so rigid that it cannot bend, or by making the surface so flexible that it will take the bending without cracking. Part of the difficulty in solving this problem lies in the fact that the deflections required to produce elastic-type failure are so small that almost complete elimination of the resilience in the substructure is required, which is practically impossible to attain. Repeated deflections of a very small order are sufficient to produce this type of failure. The literature in the art reports that deflections ranging from 0.010 to 0.050 inches are considered sufficient for failure, subject to variations due to pavements thickness, composition, asphalt grade, asphalt content, asphalt quality, prevailing temperatures, and radius of the deflection curve.

As is well known to those skilled in the art, asphalt is a bituminous material which contains bitumens occurring in nature or bitumens obtained as residue in the process of refining petroleum. Generally, asphalt contains reactive groups, notably carbon-to-carbon double bonds, hydroxy groups, carboxyl groups, and other functional groups. In terms of distribution, asphalt is much like a plastisol in that it is formed of graphitic particles suspended in a viscous liquid. The particles are of the same chemical type, but differ from each other primarily in molecular weight. The liquid phase of the asphalt is formed predominantly of lower molecular-weight condensed hydrocarbon rings, whereas the suspended graphitic particles are made up of high molecular-weight condensed hydrocarbon rings.

It is known, as described for example in U.S. Pat. No. 4,008,095, that asphalt can be modified by blending with various materials including coal or synthetic elastomers and petroleum resins. One of the difficulties with the techniques described in the '095 patent arises from the fact that the resulting blend of asphalt with an elastomeric or resinous modifying agent is not homogenous, but tends to separate into an asphalt and a modifying agent phase. Although not certain, it is believed that the reason for such separation is the fact that resinous modifying agents are not in any way chemically bonded to the asphalt. As a result, it is difficult to obtain a homogenous system by simply blending a modifying agent with the asphalt. That difficulty is compounded when it is desired to reinforce asphalt systems with fillers such as glass fibers and flake; such reinforcing fillers seem to enhance separation of the various components from the asphalt system.

Research for the modification of petroleum asphalts by polymeric additives began about 30 years ago and accelerated over the past 15 years. Typically, solid polymers with desirable characteristics are ground, melted and dispersed in the asphalt, thereby producing a mix where the polymer is encapsulated in the asphalt. Such polymers are normally added to improve the high-temperature performance of asphalt products (oils, which act as plasticizers, are similarly used to improve low-temperature characteristics). Those skilled in the art are well acquainted with the specific characteristics of and enhancements expected from each class of conventional additives.

However, no prior-art disclosure has described or considered the use of polymeric bio-additives with petroleum asphalts. Biomass wastes, especially wood from lumber sawmills, construction, forest residues, landfills, wheat straw, corn stocks, cotton wastes and other agricultural residues, are readily available in large quantities. This material, which is mostly being treated as undesirable waste, is in fact an ideal source of biomass suitable for liquefaction and further use in various additive forms. Such liquefied biomass is known to be reactive under appropriate conditions and, therefore, suitable for a reactive combination with asphalts. This invention is directed at using liquefied biomass, alone or in combination with conventional asphalt additives, to improve asphalt performance and solve its recurring damage problems, such as the pavement fatigue failures described above.

### SUMMARY OF INVENTION

30 The primary goal of this invention is an additive for petroleum asphalt that will produce a road pavement with improved durability to normal wear and tear and weathering.

In particular, an important objective of the invention is an asphalt additive capable of reducing fatigue failure in the pavement of streets and highways.

Another objective is an asphalt additive capable of reacting with conventional asphalts and produce stable mixtures that retain the additive characteristics during the life of the asphalt product.

Still another object is an asphalt additive based on biomass from waste material, thereby providing an effective solution to the problem of waste biomass accumulation around the world.

Finally, an objective of the invention is a reactive additive suitable for manipulation by those skilled in the art to produce an asphalt product tailored to meet specific application requirements.

Thus, according to this invention, a new family of additives for petroleum asphalts is disclosed, each member of the family being tailored to the needs of a particular petroleum asphalt for a specific application in paving materials, roofing materials and/or sealants. For example, if low-temperature properties are needed for cold climates, the additive can be tailored in its chemical preparation to meet this requirement. Similarly, a specific additive can be tailored to keep the asphalt pavement in hot climates from moving in what is known as rutting. Since aggregates used in hot mixes for pavements differ greatly in different geographic locations, additives can be tailored to give petroleum asphalts a greater binding power to the aggregates. Another example involves utilizing one or more polymers, capable of reacting with a liquefied biomass according to the invention, to provide “crystalline” melting points at desired temperatures, so as to extend the time available for laying the hot mix upon a pavement and compressing it by roller machinery to the desired density and level of entrapped air.

It has been discovered that the crude liquified product obtained from the direct liquefaction and/or fast-pyrolysis of biomass is completely soluble (miscible), or at least very compatible for integration to produce a homogeneous product, with all common grades of petroleum asphalt. Combined with the fact that this crude product is still very chemically reactive, this discovery provides an opportunity to create unique “compatibilizers,” that is, as this term is understood in the art, additives for and compatible with petroleum asphalts with specific properties for particular applications. These compatibilizers consist of this basic liquefied-biomass product, which is soluble in asphalts, with chemically attached polymer chains designed to provide specific properties. For example, improvements of low-temperature properties of non-brittleness, good elongation, and resilience in petroleum asphalts may be provided by the addition of rubbers and block copolymer elastomers, copolymers with a low Young's Modulus, and elastomers, respectively. Such compatibilizers are characterized by a large number of polar groups in the “mass” of the crude liquefied biomass, and by non-polar ends that provide the desired properties as an additive. Longer “short chains” and increased branching to minimize crystallization can be achieved by utilizing dimer and trimer unsaturated fatty acids, such as contained in vegetable oils, as coupling polymers. Thus, a specific reactive monomer or polymer of interest is simultaneously reacted with the crude bio-binder and the vegetable-oil or fatty-acid coupling polymer. A small amount of an organic peroxide is also preferably used to accelerate the reaction.

It should be noted that there is sufficient water in the crude bio-binder to cause hydrolysis of the vegetable oils to some percentage of fatty acids and glycerol. Thus, simultaneous reactions occur with vegetable oil, partially hydrolyzed vegetable oil, and resultant fatty acids. Vegetable oils containing unsaturated reactive groups such as soy, palm, rapeseed, cottonseed, coconut, olive, linseed, safflower, sunflower, tung, canola, castor, corn, peanut, are suitable coupling polymers. Suitable fatty acids such as oleic or linoleic acid are preferred, but many other coupling polymers containing unsaturated reactive groups or other reactive groups can be utilized.

In order to promote processing conditions and to provide additional non-polar components, it may also be beneficial to incorporate a highly aromatic, high-boiling carrier oil. A preferred material is a petroleum fluidized cracking gas oil, which is more non-polar than typical petroleum asphalt. However, it can also be anthracene oil, high-boiling phenols, high-boiling cresols, or any other oil with equivalent high-boiling characteristics. These materials act as diluents and aid in processing and solubilizing the reactive polymers.

The operating conditions for the reaction between the liquefied biomass, the coupling polymers (if any) and the reactive polymers (temperature, pressure, residence time, catalysts) are controlled during the reaction steps to produce a contemporaneous reduction in the molecular weight of the reactive polymers (especially those with unsaturated double bonds and/or tertiary hydrogen in their back-bone chains) in order to improve polymer solubility and/or homogeneity in the overall mixture. As one skilled in the art would readily recognize, this step is important with respect to solubility, miscibility and homogeneity of additives in asphalts. However, care must be taken not to reduce the molecular weight beyond the point where the desirable target properties (such as low-temperature elongation, for instance) are lost.

Various other purposes and advantages of the invention will become clear from its description in the specification that follows. Therefore, to the accomplishment of the objectives described above, this invention consists of the features hereinafter illustrated in the drawings and fully described in the detailed description of the preferred embodiment and particularly pointed out in the claims. However, such drawings and description disclose only some of the various ways in which the invention may be practiced.

### BRIEF DESCRIPTION OF THE DRAWINGS

FIG. 1 is a heat flow versus temperature graph produced by Differential Scanning Calorimetry of a type AC-20 asphalt.

FIG. 2 is a heat flow versus temperature graph produced by Differential Scanning Calorimetry of a typical crude bio-binder used to carry out the invention.

FIG. 3 is a heat flow versus temperature graph produced by Differential Scanning Calorimetry of a 50/50 wt percent mixture of the asphalt and bio-binder characterized in FIGS. 1 and 2.

FIG. 4 illustrates the steps involved in producing the bio-additives and the asphalts of the invention according to a preferred, substantially atmospheric batch process.

FIG. 5 illustrates the steps involved in producing the bio-additives and the asphalts of the invention according to a preferred high-shear, high-pressure, continuous extruder process.

FIG. 6 is a flow chart of the steps involved in the preferred embodiment of the invention.

### PREFERRED EMBODIMENTS OF THE INVENTION

We have discovered that the thermoplastic mixes of polymers derived from either the direct liquefaction of biomass, especially lignocelluloses, or the fast pyrolysis of such biomass are miscible in, or at least very compatible to produce a homogeneous blend in all proportions with, common grades of petroleum asphalts used in pavements, roofing and other asphaltic applications. This discovery led us to use this thermoplastic mix of polymers to create useful additives, designated herein as crude “bio-additives,” as special compatibilizers for various grades of petroleum asphalts. The invention also takes advantage of the high reactivity of such liquefied-biomass, thermoplastic, crude products (hereinafter defined as “bio-binders”) above about 60° C. to create various mixtures of copolymer bio-additive materials that retain their compatibility with petroleum asphalts to produce a homogeneous blend. By judiciously selecting polymer constituents with appropriate specific properties, as would be known to one skilled in the art, target enhancements can be achieved, such as extending the low-temperature properties of asphalt to even lower temperatures; extending the softening point to higher temperatures to help prevent rutting of pavements; extending the cooling time of hot mix pavement materials after laid down, thereby giving more time to compress by rolling to the proper density and air-void content; enhancing the anti-stripping properties of various grades of petroleum asphalts; and making practical the use of larger quantities of additives, thereby reducing the amount of asphalt required.

As used in this disclosure, the term asphalt is intended to refer to any black bituminous substance that is found in natural beds or is obtained as a residue in petroleum refining and that consists mainly of hydrocarbon constituents. The term biomass refers in general to any organic waste material that has been found to be suitable for conversion to liquid form (a mixture of lower molecular weight thermoplastics) by a process of liquefaction (such as by direct liquefaction or pyrolysis). In particular, and without limitation, biomass refers to organic material containing various proportions of cellulose, hemicellulose, and lignin; to wood, paper, and cardboard; to manures, to protein-containing materials, such as soybeans and cottonseeds; to grain straws, and agricultural plant stocks; and to starch-containing materials, such as grain flours. Hemicellulose is a term used generically for non-cellulosic polysaccharides present in wood. Lignocellulose refers to closely related substances constituting the essential part of woody cell walls and consisting of cellulose intimately associated with lignin.

The term liquefaction refers to processes by which biomass is converted into liquid form by the application of high pressures in the absence of air and at approximate temperatures in the 230-370° C. range. Such processes are well known in the art. For convenience the liquid materials formed by liquefaction are referred to in the art and herein as “liquefied” materials, as distinguished from “liquified” materials” formed by condensation from a vapor state. Direct liquefaction processes provide high yields of liquid products from biomass by the application of sufficient pressure, typically in the range of 200 to 3,000 psi. Indirect liquefaction processes first convert biomass to gases, which are then caused to react catalytically to produce liquids. Fast pyrolysis processes, which also produce a liquid product from biomass, are instead carried out at atmospheric pressure and at temperatures of 400-600° C. with a residence time of about two seconds, or at temperatures greater than 600° C. with residence times of less than 0.5 seconds. As used herein, the terms liquefied biomass and bio-binder are intended to refer to liquid products made either by direct liquefaction or by fast pyrolysis of biomass.

Bio-binders can have different chemical compositions and properties, depending on the liquefaction conditions. For example, lignocelluloses in wood contain about 42 wt percent oxygen; depending on the conditions of the liquefaction process, the residual oxygen typically varies between 5 and 20 wt percent. Obviously, different raw materials also yield different liquefied biomasses, which may vary in consistency from tar-like products to light oils. For example, the PERC process utilized in a DOE Waste-to-Energy pilot plant in Albany, Oreg., used shredded Douglas Fir softwood containing about 42 wt percent oxygen on a dry basis. The wood is converted to a tar with a heating value of about 15,000 Btu per pound and an oxygen content reduced to about 8-12 wt percent. This unstabilized tar is reactive at temperatures above about 150° C. Other biomass materials would yield bio-binders with comparable but different properties.

The reactivity of these bio-binders results from a significant quantity of reactive hydroxy groups in phenolic radicals. Some of the phenolics that have been identified by gas chromatography/mass spectrometry analytical analysis include 2,4,6-trimethyl phenol, 3,4,5-trimethyl phenol, 2,4,5-trimethyl phenol, 2,3,5-trimethyl phenol, 2,3,5,6-tetramethyl phenol, 2-methyl-5-(1-methylethyl) phenol, 2-(1, 1-dimethylethyl)-3-methyl phenol, 3,5-diethyl phenol, 2,3,4,6-tetramethyl phenol, 4-ethyl-2-methoxy phenol, 5-methyl-2-(1-methylethyl) phenol, 4-(1, 1-dimethylethyl)-2-methyl phenol, 2-(1, 1-dimethylethyl)-6-methyl phenol, and 2-acetyl-4,5-dimethyl phenol. Higher molecular-weight hydroxy groups have also been identified in the PERC bio-binder product. Similarly, active carboxylic acid groups have been identified in the bio-binder base contained in degraded molecules of about 150-200 molecular weight, such as 4-(1-methylethyl) benzoic acid; and active napthol groups have been identified in degraded molecules of about 180-200 molecular weight, such as 5,7-dimethyl-1-napthol and 6,7-dimethyl-1-napthol.

The reactivity of bio-binders was also confirmed by studies conducted at the University of Arizona by Y. Zhoa (M. S. Thesis, 1987), R. J. Crawford (M. S. Thesis, 1989) and G. Chen (M. S. Thesis, 1995). Samples of liquefied biomass almost entirely soluble in tetrahydrofuran (THF) were heated in an autoclave in the absence of oxygen. Starting at temperatures of about 190° C., the liquefied biomass began liberating hydrogen, carbon monoxide, methane, ethane, ethylene, propane and propylene as reaction products. The remaining liquid was up to 50 percent by weight insoluble in THF, confirming that reactions had occurred that altered the composition of the liquefied biomass.

Thus, it is well known that any biomass, especially lignocellulosic material, can be converted into heavy tar or oil by direct liquefaction or fast pyrolysis retaining most of the heating value of the biomass feedstock in a more concentrated form. Water and carbon dioxide are driven off the biomass to make it more like a petroleum crude oil. For the purposes of this invention, the temperature, pressure and residence time are adjusted to yield a very viscous liquid product, which can be pumped at about 120° C. but becomes a brittle solid at ambient temperatures. Also, for the purposes of this invention, the operating parameters of temperature, pressure and residence time are adjusted to produce a crude bio-binder that is extremely viscous at ambient temperature (with greater than 1,000 percent elongation at break), but is brittle at about −20° C. A majority of the hydroxyl groups of the cellulosic and lignin content of the biomass are removed as water and some of the carbon content is removed as carbon dioxide. A more comprehensive discussion of the reactivity of liquid bio-binder is reported in U.S. Pat. No. 5,916,826, herein incorporated by reference.

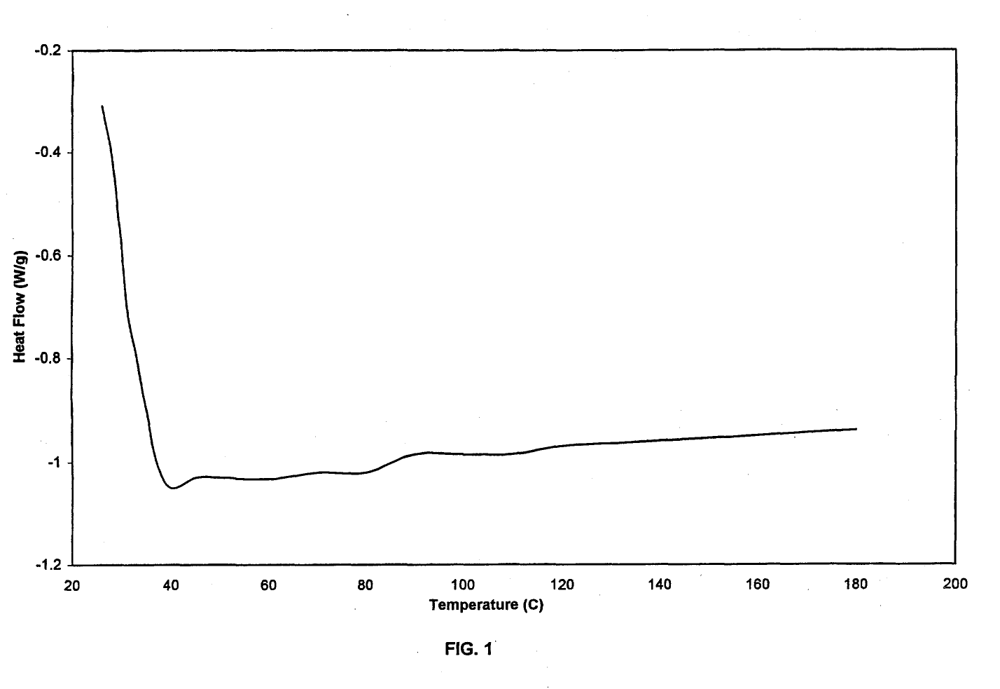

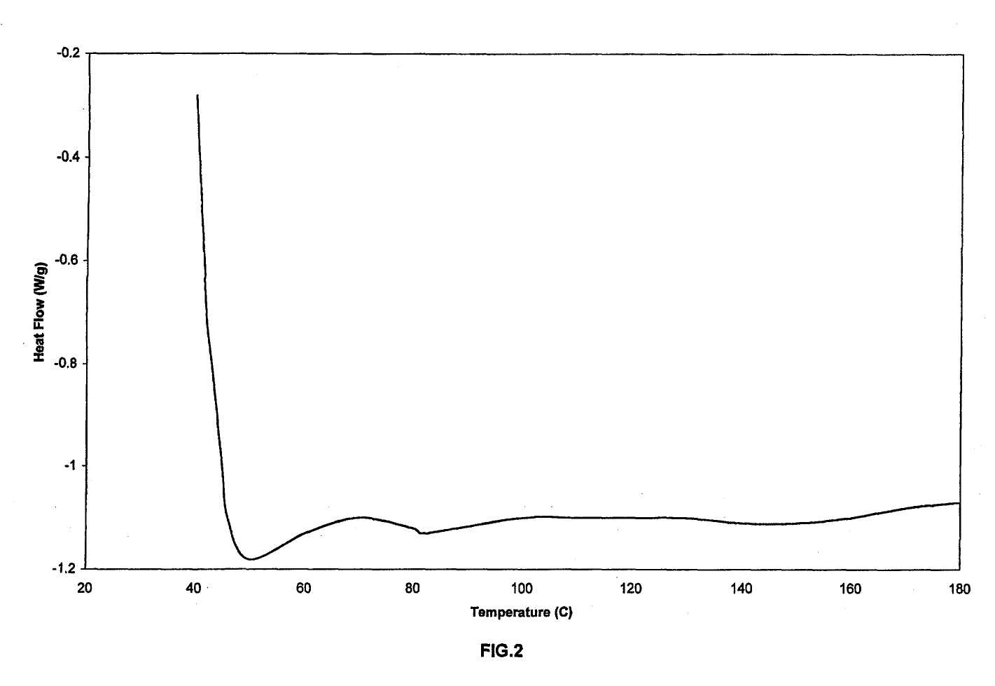

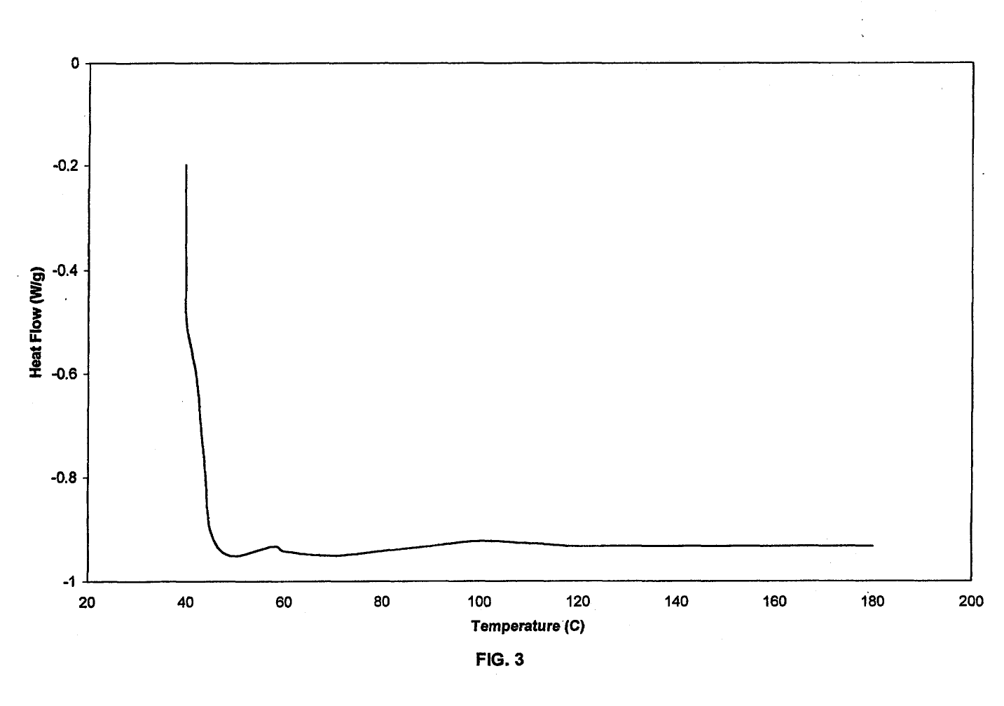

The discovery of the compatibility of liquefied biomass with asphalt was confirmed in laboratory tests that showed comparable physical properties of the two and of mixtures hereof (such as viscosity and miscibility data). For example, as illustrated in FIGS. 1-3, Differential Scanning Calorimeter (DSC) tests (heat flow versus temperature) for a typical asphalt product (AC-20 grade), a crude bio-binder base (from Douglas Fir feedstock), and a 50/50 wt percent mixture of the two showed them to be essentially the same. As one skilled in the art would readily understand, this similarity of properties is characteristic of materials that are compatible for homogeneous mixing.

Based on this affinity of crude bio-binders with conventional asphalts, the invention lies in the idea of reacting a crude bio-binder product with appropriate materials to modify an asphalt's characteristics, as desired, and then mixing the resulting compatibilizer with the asphalt. Additive materials relevant to the invention are rubber, polymers, elastomers, and their monomeric precursors (sometimes herein referred to individually or collectively as “polymers,” for simplicity). As mentioned above, dispersed polymers, elastomers, or rubbers are conventionally not solubilized in asphalts, but maintain tiny dispersed phases in an asphalt continuous phase. The advantage provided by the use of bio-binder materials is the ability to compatibilize (a term used in the art to indicate a condition that allows homogeneous dispersion) most polymers into microscopic particles prior to mixing with asphalts. This is done by heating the polymers above their melting point while intimately mixing them with the bio-binder. During the heating process, the molecular size of the polymer is preferably reduced to provide reactive sites for chemical interaction with the bio-binder. When these modified asphalts are used as pavement, roofing, or sealants, and they are cooled to atmospheric conditions, the additives are in part chemically tied to the asphalt and in part dispersed as microscopic solid particles. By adding polymers of known, desirable characteristics, the properties of the bio-binder are modified and tailored to obtain intended results after mixing with the asphalt.

The reactions between polymers and bio-binder material may be aided by the addition of organic peroxides, such as tertiary-butyl perbenzoate or tertiary-butyl hydroperoxide. As one skilled in the art would readily understand, these peroxides activate polymer reactions at temperatures above about 60° C.

We also found that linear unsaturated hydrocarbon compounds that contain varying amounts of unsaturation, such as fatty acids, vegetable oils and animal fats, can be used with the reactive bio-binder of the invention to prevent or reduce premature cross-lining (and attendant loss of reactive sites in the bio-binder) during the process of mixing and reacting the bio-binder with polymers as the temperature rises toward the polymers' melting point. Thus, the useful range of temperature operation during the bio-binder/polymer mixing step of the invention can be extended. The degree of reaction with these short-chain oils can be controlled by the quantity of oils used, the residence time at any given temperature, and the use of organic or inorganic oxidizers such that, when desirable, the amount of cross-lining can be held sufficiently low to maintain the thermoplastic nature of the compatibilizer (i.e., so that it can be melted and frozen without significant decomposition). In addition, these short-chain oils tend to increase slightly the molecular weight of the resulting polymeric-mixture components, thereby also yielding an increase in viscosity, elastic flow (non-Newtonian), and elongation in the solid state to the product.

Linseed oil, which contains about 20 wt percent each of two unsaturated fatty acids, namely oleic acid and linoleic acid, was found to be a useful short-chain oil for the purposes described. Other suitable oils are palmitoleic acid, ricinoleic acid, myristoleic, eleostearic, hydroxyricinoleic, and arachidonic acid. These common fatty acids have carbon chains varying in length from 16 to 20 carbon atoms, with at least one double bond between carbon atoms in the chain. The degree of unsaturation in these acids provides the reactivity that enables their reaction with active crude bio-binder sites and prevents cross-linking.

According to the invention, the crude bio-binder is reacted with selected polymers, preferably in the presence of a fatty acid, as described, and also preferably in the presence of a peroxide compound to facilitate the reaction. The resulting product, a bio-additive compatibilizer for the asphalt to be used in a given application, is then mixed with and incorporated into the asphalt. As discussed above, we discovered that these mixtures are miscible or at least compatible to produce homogeneous blends in all proportions.

We developed two preferred methods of producing bio-additives and asphalts according to the invention. A batch process operating near atmospheric pressure provides low capital costs and flexibilities for tailoring asphalt additives in relatively small quantities. A continuous process that can be operated at any desired pressure, up to about 8,000 psi, is more suitable for larger quantities.

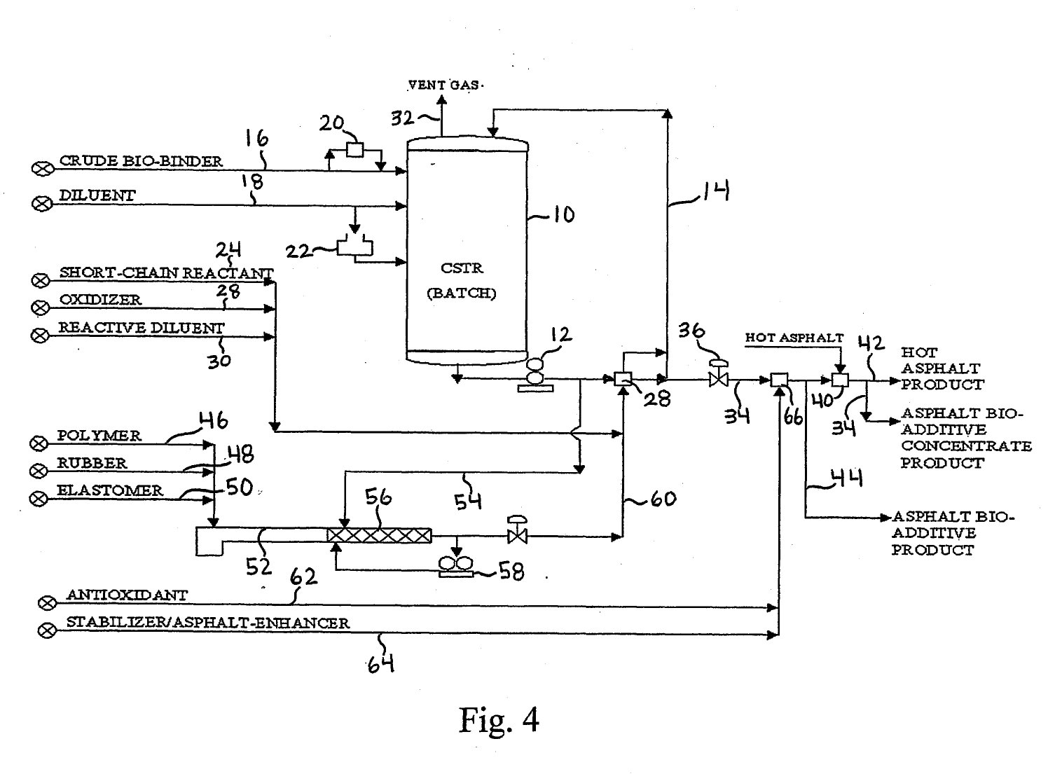

FIG. 4 illustrates the steps involved in producing the bio-additives and asphalts of the invention in the nearly atmospheric batch process. Crude bio-binders are stable at low temperature in the absence of air. As temperature rises and/or air exposure increases, though, the material begins cross-linking and/or oxidizing, respectively. Thus, typical crude bio-binders are already reactive at about 90° C. (or at about 60° C. with the aid of peroxides), but the system of the invention needs to be at a higher temperature in order to properly disperse the other reaction constituents (i.e., the polymers, elastomers, and/or rubbers).

The main unit for the process is a batch vessel 10 capable of operating as a continuous stirred tank reactor (CSIR) with an external gear pump 12 and a recirculating loop 14. The crude bio-additive 16 and a non-reactive liquid diluent 18, such as a heavy oil used to increase the fluidity of the blend, are fed into the vessel 10, where they are mixed and heated to about 100° C., so that the bio-binder is melted to form a homogenous liquid mixture. An alternative option would be to preheat the bio-binder feed 16 in a heater 20, and pump it as a liquid into the batch vessel. Another option would be to also preheat the diluent 18 in a heater 22 and pump it into the batch vessel, which would lower the time required to heat the mixture in the reactor 10. When a well blended mixture is achieved in the reactor, the temperature is gradually raised up to above the melting or swelling temperatures of any polymer or other additive intended to be added to carry out the steps of the invention (typically, up to a temperature of about 125° C., but temperatures as high as 450° C., with a short residence time, may be required to fully swell certain rubber components).

If short-chain reactants 24 are used, such as unsaturated vegetable oils and/or unsaturated fatty acids, they are pumped into the batch vessel 10 and mixed homogeneously into the vessel ingredients by means of the high-shear mixer 26 in the recirculation loop 14. When thoroughly mixed with the recirculating bio-binder mixture (preferably at a temperature increased to about 120° C.), an oxidizer 28 is also introduced in minute quantities to accelerate the reactions. An option is to introduce other appropriate co-reactants, such as reactive diluent 30. Gases produced by reactions occurring in the system are released through a vent 32 in the vessel 10. When reactions are completed, while continuing the circulation of the batch vessel, the bio-additive product 34 can be withdrawn through a valve 36 and mixed with asphalt 38 in a mixer 40 to produce a final asphalt product 42, which is sent to storage or tank-truck transport for immediate use. An alternative is to store or transport directly the asphalt bio-additive product 34, without mixing it with asphalt, for future use. Still another option is to blend the asphalt bio-additive in a 50/50 or similar mixture with asphalt, and withdraw it as an asphalt bio-additive concentrate 44 for easier handling and storage.

In order to produce higher performing asphalt bio-additives using conventional additives, selected polymers 46, rubber 48, and/or elastomers 50 are reacted with the bio-binder mixture in the reactor 10. These materials have high viscosities, such that a preferred method of dispersion into the asphalt bio-binder is to first melt them and then utilize the high shear mixer 28 to produce enhanced asphalt bio-additives. Further, it is desirable to accomplish this final dispersion and/or reactions in the shortest time possible in order to minimize holding the product additives at high temperatures. Consequently, the polymer feed 46 is preferably first melted in a single-screw extruder 52, and then dispersed in an intermediate stage in a recycling stream 54 from the batch vessel. A static mixer 56 and a gear pump 58 accomplish this intermediate dispersion. Thus, the resulting polymer dispersion 60 is closer to the viscosity and composition of the bio-binder mixture in the batch vessel 10. Antioxidants 62 and any other stabilizers 64 that might be needed for any specific asphalt additive are added as a finishing step using mixer 66.

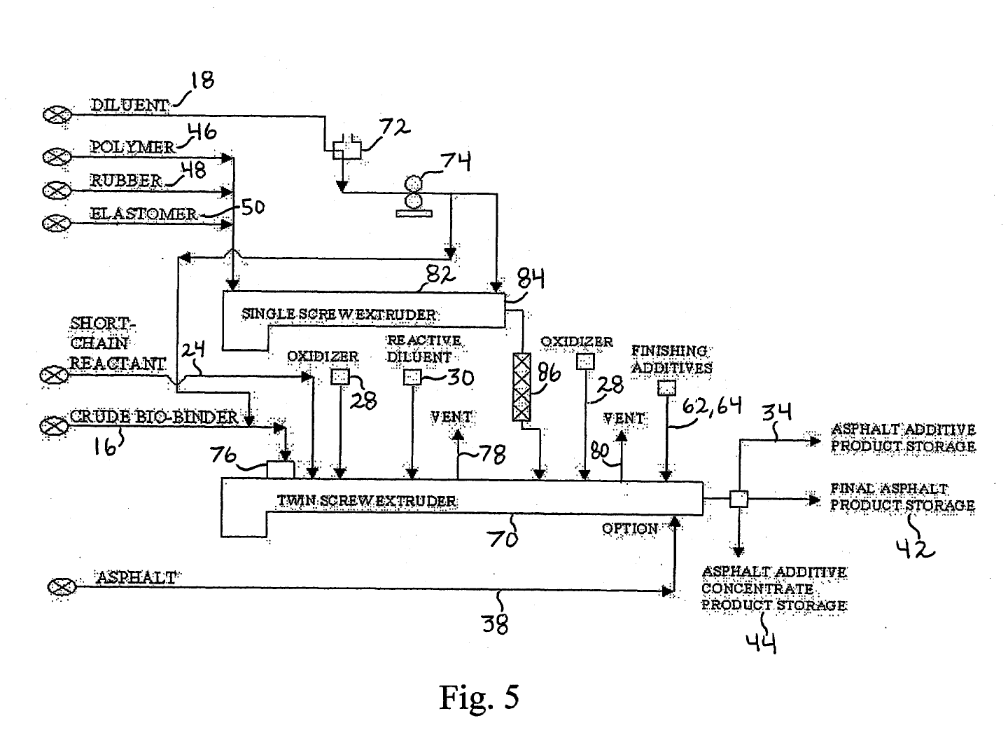

According to another embodiment of the invention illustrated in FIG. 5, the same process steps are carried out using the high-shear, high-pressure environment of extruder units to fluidize the components and facilitate their reaction according to the invention. This approach takes advantage of technology developed for the plastics industry and yields higher performing asphalt bio-additives in a more efficient, lower cost operation, which is particularly suitable for large-scale production.

The key machine of this process is a twin screw extruder 70 which serves as the major reactor in the continuous process, analogous to the batch vessel 10 used in the batch process described in FIG. 4. In order to produce a given asphalt bio-additive, all materials are metered into the process on a continuous basis. When switching production to a different bio-additive, a certain amount of waste is generated while each part of the system is cleaned out by the flow of different materials, but most of the waste can be blended back into the process as production continues.

According to the process of FIG. 5, a diluent 72 is heated to a temperature above 100° C. in a heater 72 and pumped through gear pump 74 to be mixed with crude bio-binder 16, and then fed into the feed end 76 of the twin screw extruder 70. The feed temperature is kept at about 100° C. to 110° C. The feed mixture is preferably heated to about 120° C. by the extruder by the time it reaches the injection point of the short-chain reactant 24 (vegetable oil), and shortly thereafter the injection of the oxidizer 28. Reactions take place with constant mixing in the extruder, which is designed to be an excellent mixer. Shortly thereafter the injection of a reactive diluent 30 is optional. A vent 78 relieves the process of any gases of the system for those formulations that generate small quantities of gases. A second vent 80 may be provided for more sever gas formation.

Reactions are completed in the extruder, usually within a total residence time of 2 to 20 minutes. If no polymer enhancement is desired, the asphalt additive is mixed with final finishing additives (antioxidants 62 and stabilizers/enhancers 64) and sent to product storage as an asphalt additive product 34.

When polymer enhancement is desired, polymers 46, rubbers 48, and/or elastomers 50 are first melted in a single-screw extruder 82 and the diluent 18 is injected in the metering/mixing section 84 of the extruder. Homogeneous mixing and dispersion of the polymer in the diluent is further achieved in a static mixer 86 prior to injection into the twin-screw extruder 70. Further reactions are achieved, if desired, by injecting oxidizer 28 into the extruder. Finally, the bio-additive so produced can be mixed with an asphalt 38 directly in the extruder 70 to provide a final asphalt product 42 for immediate use. Again, alternatively, the asphalt bio-additive product can also be stored or shipped as an asphalt bio-additive 34 without being mixed with asphalt; or it can be fashioned as an asphalt bio-additive concentrate 44 at various blend ratios.

An asphalt product containing from 2 to 30 wt percent bio-additive has been found to exhibit excellent enhancement characteristics over the base asphalt. Because of the relatively low cost of bio-binder material obtained from waste, though, blends with greater percentages of bio-additive may still be or become economical and provide desirable enhanced performance.

It is noted that the two extruders 70 and 82 could be combined in a single unit with multiple stages. As the material traveled along the extruder, each feed stream would be added to the mix at the appropriate stage in conformity with temperature, mixing and residence-time requirements.

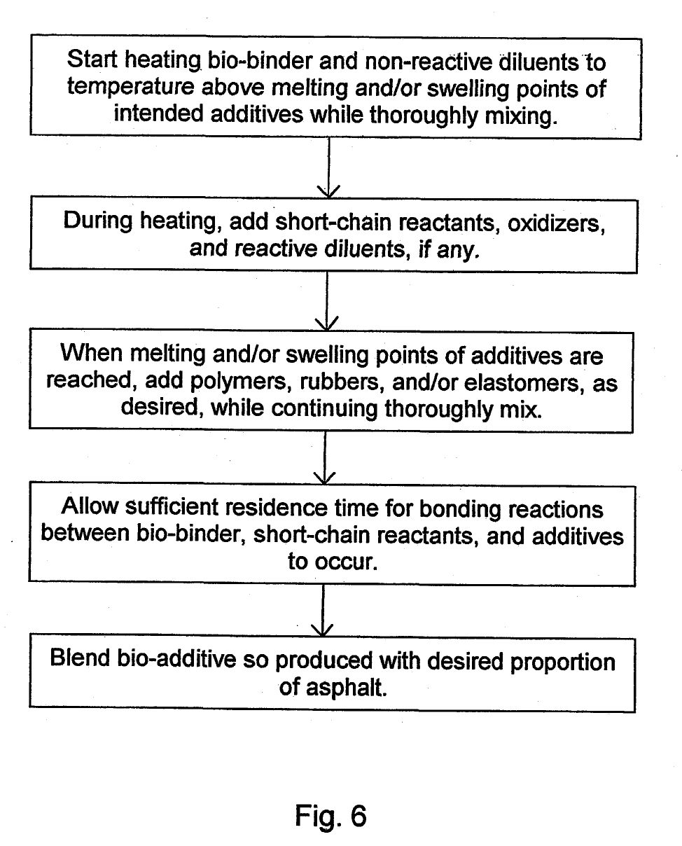

The process steps outlined in FIGS. 4 and 5 describe preferred conditions for preparing many finished bio-additives according to the invention, but it is clear that other conditions may be required for certain specific end properties of the final asphalt product. FIG. 6 is a flow chart of the steps involved in the preferred embodiment of the invention.

As mentioned, the major reactant to carry out the invention is the crude bio-binder derived from biomass by direct liquefaction or fast hydrolysis. Suitable polymers 12 include, for example, copolymers elastomers with low Young's Modulus, block styrene-butadiene elastomeric polymers, various ethylene-vinyl acetate copolymers, cross-linked tire rubber, acrylic acid polymers, and branched polyolefin polymers. Suitable diluents 18 include petroleum FCC (Fluidized Catalytic Cracking Main Column Bottoms), heavy crude bottoms, waste motor oils, aromatic phenols, aromatic cresols, anthracene oils and the various modifications of these materials.

The invention is illustrated by the following examples. Initially, in order to show that biomass liquefaction products are similar to asphalts, they were tested using asphalt standard test.

Three crude bio-binders were produced by liquefaction of Douglas Fir wood flour under liquefaction conditions arbitrarily defined as mild, moderate and severe. These samples and a sample of Chevron AC-20 asphalt (from an El Paso, Tex., refinery) were characterized in a laboratory using test equipment adopted under the Strategic Highway Research Program (SHRP), with the results reported in Table 1.

TABLE 1

| | Douglas Fir Liquefaction | | | |
|---|---|---|---|---|
| Test | Mild | Moderate | Severe | Chevron AC-20 |
| Dynamic Shear Modulus | 70 | 76 | 87 | 68 |
| (G*/sind, 1.00 kPa), | | | | |
| Penetration, 22° C. (mm) | 160 | 59 | 0 | 60 |
| Low Temperature | | | | |
| Elongation (%), 4° C. | 1.0 | 0.5 | 0.3 | 3.0 |
| Penetration, 4° C. (mm) | 0 | 11 | 0 | 21 |

As those skilled in the art would readily recognize, these results indicate a high degree of compatibility of the three bio-binder samples with the asphalt. The three samples could be melted and added in all proportions to AC-20 asphalt at 110° C.

### EXAMPLE 1

Because of the instability of bio-binders at high temperatures, such as when heated above about 110° C., it may be necessary to use capping agents to prevent their deterioration, evidenced by smoking, when higher process temperatures are contemplated. Accordingly, the intended goal was to stop the smoking so that the heated products could pass the flash-point test of at least 230° C. This was critical so the products could result as a direct substitute in the hot mix plant where the asphalt is heated to over 230° C. routinely. Thus, the mild bio-binder of Table 1 was used for testing reactions with vegetable oils, acrylic monomers, and thermoset polyester monomers.

A. A mixture of bio-binder (400 gm) and linseed oil (40 gm) was melted at about 120° C., at which point a slight reaction was observed. By adding a few drops of tertiary butyl peroxybenzoate (TBPB), a more definite reaction occurred. When the sample was then heated above 150° C., the degree of smoking was found to be much lower than in bio-binder alone, passing the flash point test at 230° C.

Samples of this reaction product were cast in approximately one-mm sheets and evaluated for cracking at low temperatures. The initial cracking temperature was approximately −14° C. for the product, which showed an improvement compared to an initial cracking temperature of 10° C. for the untreated bio-binder alone, of 8° C. for the AC-20 asphalt, and of 11° C. for a 50/50 wt blend. These data indicate that reactions with the bio-binder can be advantageously utilized to reduce the lower-use temperature of asphalt for pavement applications.

B. A mixture of 400 gm of the same mild bio-binder, 20 gm of methylmethacrylate (MMA) monomer, and 20 gm of linseed oil was prepared at about 110° C. and stirred. Then, it was heated to the point where a slight reaction began to occur at about 150° C.; several drops of TBPB were added and a significant reaction ensued indicating that capping was occurring. Again, the mixture passed the flash-point test. A 20 wt percent mixture of this product with AC-20 asphalt was prepared at about 150° C. Dynamic-shear rheometry data of the blend and the asphalt showed that the upper-use temperature was increased from about 64° C. for asphalt to 76° C. for the blend. This is a material improvement to help prevent rutting in pavement applications.

### EXAMPLE 2

This example shows an asphalt bio-additive that improves both low-temperature and high-temperature properties of petroleum asphalts by incorporating a polypropylene-ethylene copolymer elastomer (55/45 wt percent) that has a low Young's Modulus.

500 gm of bio-binder were mixed well with 400 gm of Texaco fluidized catalytic cracking main column bottoms (FCC) as a diluent and heated to 120° C. in a vessel. 100 gm of linseed oil and 0.2 gm of tertiary butyl peroxybenzoate as oxidizer were added to the bio-binder while mixing and continuing to gradually raise the temperature. When the blend reached 160° C. (which is approximately 5° C. above the melting temperature of a polypropylene-ethylene copolymer elastomer), 200 g of the copolymer elastomer were added to the reactive blend, along with 1,200 gm of an AC-20 asphalt for dilution and easier mixing.

After about five minutes of continuous high-shear mixing at temperatures between 160° C. and 170° C., another 0.2 gm of tertiary butyl peroxybenzoate was added. The resulting bio-additive was mixed with 17.8 Kg of AC-20 asphalt at about 160° C. The bio-additive and the asphalt exhibited complete compatibility, yielding a thoroughly homogeneous blend (about 5 wt percent bio-additive).

This blend passed all tests for characterization as a performance grade per Strategic Highway Research Program (SHRP) testing. The tested performance grade for the blend was close to 64/28 (i.e, a use range of 64° C. to −28° C.), compared to 58/10 for AC-20 asphalt alone.

### EXAMPLE 3

Ground tire rubber is added to asphalt to provide several road benefits. These are increased low-temperature ductility, increased adhesion to aggregates, improved resistance to aging, increased deformative elastic recovery, and reduced tire noise. Normally about 18-20 wt percent of finely ground rubber (less than about 40 mesh) is added to asphalt and heated for 1-3 hours at a temperature above 220° C. to achieve these properties. Typically the rubber is swelled at that high temperature by the oils and asphalt components to form a gel-like network in the asphalt. An objective of the invention is to be able to use a coarser ground rubber (10 mesh or larger), and to achieve similar or better results with less rubber.

Accordingly, the mild bio-binder mentioned above was reacted with course tire rubber in the following manner. 500 gm of course-ground rubber was soaked in 750 gm of FCC oil at 120° C. for 3 hours to swell the rubber. This mixture was fed into an extruder at about 450° C. to heat and shear the rubber. At the metering section of the extruder (near the outlet end), the bio-additive mixture from Example 1A was injected using a gear pump at a rate designed to produce a final output product containing about 30 wt percent rubber. This bio-additive product was added to asphalt at a 12 wt percent concentration in a stirred vessel heated to about 170° C. Microscopic analysis revealed that the rubber particles in the dispersed phase were smaller than those obtained with fine-ground rubber according to conventional practice. This product is found to exhibit properties equivalent to conventional rubberized asphalts using considerably lower levels of rubber (10-12 versus 18-20 wt percent).

### EXAMPLE 4

Ethylene-vinyl acetate copolymer elastomers are used commercially as additives (in quantities of about 5 wt percent of the whole) to improve both low-temperature and high-temperature properties of asphalts. The polar groups in these copolymers increase elastic deformation and, in general, also durability, toughness, tenacity and resistance to cracking.

A commercial grade with 19 wt percent vinyl acetate, 81 wt percent ethylene, and a melt flow index of about 150 gm/min was used in the formulation of this example. 300 gm of bio-binder were mixed well with 240 gm of Texaco FCC oil as a diluent and heated to 120° C. in a vessel. 60 gm of linseed oil and 0.1 gm of tertiary butyl peroxybenzoate as oxidizer were added to the bio-binder while mixing and continuing to gradually raise the temperature. When the blend reached 140° C., 120 gm of the ethylene-vinyl acetate copolymer elastomer and 120 gm of low density polyethylene were added to the reactive blend.

After about five minutes of continuous high-shear mixing at temperatures between 140° C. and 150° C., another 0.2 gm of tertiary butyl peroxybenzoate was added. The resulting bio-additive was mixed with 11.4 Kg of AC-20 asphalt at 160° C. (yielding a product containing only about 1 wt percent each of the ethylene-vinyl acetate copolymer elastomer and the low density polyethylene). The bio-additive and the asphalt exhibited complete compatibility. All desired properties were maintained using these lower levels of polymers, especially ethylene-vinyl acetate copolymer.

### EXAMPLE 5

This example shows an asphalt bio-additive that improves low-temperature properties of petroleum asphalts by incorporating a styrene-butadiene-styrene block copolymer elastomer. This bio-additive is tailored for use at a low level of only 2 wt percent in an AC-20 asphalt intended for use in climates that cause mild road-pavement failures at low winter temperatures.

500 gm of bio-binder were mixed well with 400 gm of Texaco FCC as a diluent and heated to 120° C. in a vessel. 100 gm of linseed oil and 0.2 gm of tertiary butyl peroxybenzoate as oxidizer were added to the bio-binder while mixing and continuing to gradually raise the temperature. When the blend reached 160° C., 200 gm of styrene-butadiene-styrene block copolymer elastomer were added, along with 1,100 gm of an AC-20 asphalt.

After about five minutes of continuous high-shear mixing at temperatures between 160° C. and 170° C., another 0.2 gm of tertiary butyl peroxybenzoate was added. The resulting bio-additive was mixed with 52.8 Kg of AC-20 asphalt at about 160° C. The bio-additive and the asphalt exhibited complete compatibility, yielding a thoroughly homogeneous blend (about 2 wt percent bio-additive). This asphalt additive is expected to improve asphalts used in pavements in temperate zones.

### EXAMPLE 6

Roof membranes containing asphalt are used on large commercial buildings. Such asphalt roof membranes modified by polymers or rubbers are often referred to in the industry as Modbit membranes. Modification of asphalt with about 10 wt percent of styrene-butadiene-styrene (SBS) copolymer elastomer produces novel membrane structures with outstanding properties. Therefore, the invention is used to produce a roof membrane with properties comparable or better than conventional Modbit membranes that incorporate only SBS elastomer in asphalt.

The mild bio-binder was utilized in the following manner. 50 Kg of fine-ground rubber was soaked in 500 Kg of FCC oil at 120° C. for 3 hours to swell the rubber This mixture was fed into an extruder at about 425° C. to heat and shear the rubber. At the metering section of the extruder, a bio-additive consisting of 300 Kg of mild bio-binder and 100 Kg of linseed oil (prepared as detailed in Example 1A) was injected using a gear pump at a rate designed to produce a final output product containing the same ratios specified above. This bio-additive product was blended in a twin-screw extruder with a roofing asphalt in a ratio of 30 wt percent bio-additive and 70 wt percent asphalt. Also, 50 Kg of styrene-butadiene-styrene copolymer elastomer was fed in the feed section of the twin extruder. 2,333 Kg of roofing asphalt was fed into the mid-section of the extruder by means of a gear pump. This type of extruder provides the means for good mixing, for injection of the copolymer elastomer, and for the application of the resulting product directly over reinforcement mats commonly used in roofing membranes through a special die at the extruder's outlet.

### EXAMPLE 7

Same as Example 6, except that the 50 Kg of SBS elastomer is replaced with 50 Kg of low density polyethylene. This produces a roofing membrane with greater resistance to degradation by sunlight.

### EXAMPLE 8

Same as Example 5, except that the addition of 1,100 gm of AC-20 asphalt is incorporated earlier, at the time when the 500 gm of bio-binder is mixed with 400 gm of Texaco FCC and heated to 120° C. This allows some reaction of the bio-binder with this portion of asphalt for additional improvement of physical properties.

### EXAMPLE 9

Same as Example 6, except that the 50 Kg of SBS copolymer elastomer is replaced by 25 Kg of low-density polyethylene and the fine-ground tire rubber is increased from 50 Kg to 75 Kg. This results in a 30 wt percent concentration of bio-additive in the roofing asphalt, and gives properties between those found in Examples 6 and 7.

### EXAMPLE 9

Same as Example 6, except that the 50 Kg of SBS copolymer elastomer is deleted and the fine-ground rubber is increased to 100 Kg. This results in a 30 wt percent concentration of bio-additive in the roofing asphalt, and gives properties approaching those found in Example 6.

In summary, this invention provides a process for creating finished bio-additives tailored to various grades of petroleum asphalts. The bio-additive of the invention is a solubilized compatibilizer that interacts with the clusters of asphaltenes present in petroleum asphalts to yield a reacted, stable product. The bio-additives result from bio-binders capable of reacting with useful asphalt additives and maintaining a degree of reactivity and complete compatibility with petroleum asphalts. Thus, the specific petroleum asphalts can be modified according to the invention to suit a given aggregate for paving, roofing, and other applications.

Various changes in the details, steps and components that have been described may be made by those skilled in the art within the principles and scope of the invention herein illustrated and defined in the appended claims. Therefore, while the present invention has been shown and described herein in what is believed to be the most practical and preferred embodiments, it is recognized that departures can be made therefrom within the scope of the invention, which is not to be limited to the details disclosed herein but is to be accorded the full scope of the claims so as to embrace any and all equivalent apparatus and procedures.

We claim:

1. An asphalt product comprising a thermoplastic bio-binder and an asphalt.

2. The asphalt product of claim 1, further comprising a reactive additive reactively mixed with the bio-binder.

3. The asphalt product of claim 2, wherein said additive is selected from the group consisting of a polymer, a rubber, an elastomer, or a mixture thereof.

4. The asphalt product of claim 1, further comprising a coupling polymer reactively mixed with the bio-binder and the asphalt.

5. The asphalt product of claim 2, further comprising a coupling polymer reactively mixed with the bio-binder and the asphalt.

6. The asphalt product of claim 4, wherein said coupling polymer is selected from the group consisting of soy oil, palm oil, rapeseed oil, cottonseed oil, coconut oil, olive oil, linseed oil, safflower oil, sunflower oil, tung oil, canola oil, castor oil, corn oil, peanut oil, oleic acid, linoleic acid, palmitoleic acid, ricinoleic acid, myristoleic, eleostearic, hydroxyricinoleic, arachidonic acid, and mixtures thereof.

7. The asphalt product of claim 1, further comprising a reactive additive selected from the group consisting of a polymer, a rubber, an elastomer, or a mixture thereof reactively mixed with the bio-binder; and a coupling polymer selected from the group consisting of soy oil, palm oil, rapeseed oil, cottonseed oil, coconut oil, olive oil, linseed oil, safflower oil, sunflower oil, tung oil, canola oil, castor oil, corn oil, peanut oil, oleic acid, linoleic acid, palmitoleic acid, ricinoleic acid, myristoleic, eleostearic, hydroxyricinoleic, arachidonic acid, and mixtures thereof.

8. A process for producing an improved petroleum asphalt product from biomass material, comprising the following steps:
(a) preparing a liquefied bio-binder from said biomass material; and
(b) blending the liquefied bio-binder with a petroleum asphalt at a temperature sufficiently high to produce a bonding reaction between the liquefied bio-binder and the petroleum asphalt, thereby yielding a substantially homogeneous stable blend.

9. The process of claim 8, further including the step of blending a reactive additive with the liquefied bio-binder prior to step (b) at a temperature sufficiently high to fluidize the reactive additive.

10. The process of claim 9, wherein said additive is selected from the group consisting of a polymer, a rubber, an elastomer, or a mixture thereof.

11. The process of claim 8, further including the step of blending a coupling polymer with the liquefied bio-binder prior to step (b).

12. The process of claim 11, wherein said coupling polymer is selected from the group consisting of soy oil, palm oil, rapeseed oil, cottonseed oil, coconut oil, olive oil, linseed oil, safflower oil, sunflower oil, tung oil, canola oil, castor oil, corn oil, peanut oil, oleic acid, linoleic acid, palmitoleic acid, ricinoleic acid, myristoleic, eleostearic, hydroxyricinoleic, arachidonic acid, and mixtures thereof.

13. The process of claim 8, further including the step of blending an oxidizer with the liquefied bio-binder and coupling polymer prior to step (b).

14. The process of claim 8, wherein said step (a) is carried out by direct liquefaction of the biomass material.

15. The process of claim 8, wherein said step (a) is carried out by fast pyrolysis of the biomass material.

16. An asphalt product produced by the process of claim 8.

17. An asphalt product produced by the process of claim 9.

18. An asphalt product produced by the process of claim 11.

19. A process for producing a reactive bio-additive for-petroleum asphalt from biomass material, comprising the following steps:
(a) preparing a liquefied bio-binder from said biomass material; and
(b) blending the liquefied bio-binder with a reactive additive at a temperature sufficiently high to fluidize the reactive additive and produce a bonding reaction between the liquefied bio-binder and the reactive additive, thereby yielding a substantially homogeneous stable blend.

20. The process of claim 19, wherein said reactive additive is selected from the group consisting of a polymer, a rubber, an elastomer, or a mixture thereof.

21. The process of claim 19, further including the step of blending a coupling polymer with the liquefied bio-binder prior to step (b).

22. The process of claim 21, wherein said coupling polymer is selected from the group consisting of soy oil, palm oil, rapeseed oil, cottonseed oil, coconut oil, olive oil, linseed oil, safflower oil, sunflower oil, tung oil, canola oil, castor oil, corn oil, peanut oil, oleic acid, linoleic acid, palmitoleic acid, ricinoleic acid, myristoleic, eleostearic, hydroxyricinoleic, arachidonic acid, and mixtures thereof.

23. A reactive bio-additive produced by the process of claim 19.

24. A reactive bio-additive produced by the process of claim 21.

25. An asphalt bio-additive product comprising a thermoplastic bio-binder and a reactive additive reactively mixed with the bio-binder.

26. The asphalt bio-additive product of claim 25, wherein said additive is selected from the group consisting of a polymer, a rubber, an elastomer, or a mixture thereof.

27. The asphalt bio-additive product of claim 25, further comprising a coupling polymer reactively mixed with the bio-binder.

28. The asphalt bio-additive product of claim 27, wherein said coupling polymer is selected from the group consisting of soy oil, palm oil, rapeseed oil, cottonseed oil, coconut oil, olive oil, linseed oil, safflower oil, sunflower oil, tung oil, canola oil, castor oil, corn oil, peanut oil, oleic acid, linoleic acid, palmitoleic acid, ricinoleic acid, myristoleic, eleostearic, hydroxyricinoleic, arachidonic acid, and mixtures thereof.

29. An asphalt bio-additive product comprising a thermoplastic bio-binder and a coupling polymer reactively mixed with the bio-binder.

30. The asphalt bio-additive product of claim 29, wherein said coupling polymer is selected from the group consisting of soy oil, palm oil, rapeseed oil, cottonseed oil, coconut oil, olive oil, linseed oil, safflower oil, sunflower oil, tung oil, canola oil, castor oil, corn oil, peanut oil, oleic acid, linoleic acid, palmitoleic acid, ricinoleic acid, myristoleic, eleostearic, hydroxyricinoleic, arachidonic acid, and mixtures thereof.
